(19) United States
(12) Patent Application Publication
(10) Pub. No.: US 2016/0299405 A1
(43) Pub. Date: Oct. 13, 2016

(54) GRADIENT INDEX (GRIN) BACKPLANE ROUTING

(71) Applicant: EMPIRE TECHNOLOGY DEVELOPMENT LLC, Wilmington, DE (US)

(72) Inventors: Michael Keoni Manion, Seattle, WA (US); Benjamin William Millar, Rosebery, New South Wales (AU); George Charles Peppou, Hornsby Heights, New South Wales (AU)

(73) Assignee: EMPIRE TECHNOLOGY DEVELOPMENT LLC, Wilmington, DE (US)

(21) Appl. No.: 15/100,989

(22) PCT Filed: Feb. 25, 2014
(86) PCT No.: PCT/US14/18217

§ 371 Date: Jun. 2, 2016

(51) Int. Cl. G02F 1/295

(52) U.S. Cl. CPC G02F 1/295; B82Y 20/00

(57) ABSTRACT

Technologies are generally described to employ an optical effect, such as Pockels effect to direct an optical communication signal within a gradient index (GRIN) backplane. An electric field may be created between two or more electrodes located on different surfaces of the GRIN backplane in response to an application of electrical excitation to at least one of the electrodes. The electric field may be configured to change an orientation of nanoparticles in at least a portion of GRIN material comprising the GRIN backplane so as to control a direction of one or more optical pathways within the GRIN backplane. Propagation of an optical communication signal between one or more components mounted on one or more surfaces of the GRIN backplane may be facilitated via the controlled direction of the optical pathways, which may enable control of routing, including switching, of the optical communication signal to a particular optical pathway.

### BACKGROUND

Unless otherwise indicated herein, the materials described in this section are not prior art to the claims in this application and are not admitted to be prior art by inclusion in this section.

Purely electrical backplanes provide a mechanical and electrical framework for operation and communication among, various components. Electrical communication signals may present inherent limitations on communication bandwidth and quality. For example, electrical signals may be susceptible to interference, such as noise from other components on the backplane or from external sources. On the other hand, an increasingly higher number and variety of electronic components ma have the capability to support optical communication. Optical communication signals may be less susceptible to interference, compared to electrical communication signals, and may provide comparatively much wider bandwidths.

Current attempts to support both electrical and optical communications on backplanes, however, could use some improvements and/or alternative or additional solutions in order to effectively and efficiently communicate optical signals.

### SUMMARY

The present disclosure generally describes techniques to employ an optical effect to direct an optical communication signal within a gradient index (GRIN) backplane.

According to some examples, gradient index (GRIN) backplanes are described. An example GRIN backplane may include a planarly formed GRIN material, where the GRIN material includes at least one refractive index that varies along orthogonal x, y, and/or z axes of the GRIN material. The example GRIN backplane may also include nanoparticles in at least a portion of the GRIN material, where a section of at least one optical pathway is formed in the portion of the GRIN material based on variation of the refractive index. The plurality of nanoparticles may enable the refractive index in the portion of the GRIN material to be changed in response to an electric field, where the change in the refractive index in response to the electric field results in a change in the section of the optical pathway in the portion of the GRIN material.

According to other examples, apparatuses are described. An example apparatus may include a GRIN backplane that includes nanoparticles that determine at least in part a direction of one or more optical pathways within the GRIN backplane based on a variation of at least one refractive index of the GRIN backplane. The example apparatus may also include components on one or more surfaces of the GRIN backplane, where two or more of the components may be communicatively coupled through the optical pathways within the GRIN backplane. The example apparatus may further include two or more electrodes on at least one surface of the GRIN backplane, where the electrodes may be configured to create an electric field between the electrodes in response to application of a voltage and/or a current. The example apparatus may yet further include an optical interface coupled to an edge of the GRIN backplane, where the optical interface may be configured to receive an optical communication signal and provide the optical communication signal to at least one of the components through the optical pathways within the GRIN backplane, where the nanoparticles may be responsive to the electric field to change the refractive index of the GRIN backplane to cause a change in the direction of the optical pathways.

According to further examples, methods to fabricate a GRIN backplane are provided. An example method may include forming at least one sheet of GRIN material, where the sheet of GRIN material includes at least one refractive index that varies along orthogonal x, y, and/or z axes of the GRIN material. The example method may also include placing nanoparticles into at least a portion of the GRIN material, where a section of at least one optical pathway is formed in the portion of the GRIN material based on the variation of the refractive index, where the nanoparticles may enable the refractive index in the portion of the GRIN material to be changed in response to an electric field. The method may further include mounting two or more electrodes on different surfaces of the sheet of GRIN material, where electrodes may be configured to create the electric field between the different surfaces of the sheet of GRIN material in response to application of electrical excitation to the electrodes.

According to yet further examples, methods to employ an optical effect to direct an optical communication signal within a GRIN backplane are provided. An example method may include forming an electric field between two or more electrodes located on at least one surface of the GRIN backplane by application of electrical excitation to at least one of the electrodes, where the electric field may be configured to change an orientation of nanoparticles in the GRIN backplane so as to control a direction of one or more optical pathways within the GRIN backplane. The example method may also include facilitating propagation of an optical communication signal between two or more components via the controlled direction of the optical pathways.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which;

FIG. 1 illustrates a two-dimensional (2D) cross section of an example gradient index (GRIN) backplane configured to employ an optical effect to direct an optical communication signal within the GRIN backplane;

FIG. 2 illustrates example configurations of an electric field that may be created within a GRIN backplane;

FIG. 3 illustrates an example voltage effect on an optical communication signal routing behavior within a GRIN backplane;

FIG. 4 illustrates an example three-dimensional (3D) GRIN backplane configured to employ an optical effect to direct an optical communication signal within the GRIN backplane;

FIG. 5 illustrates an example 3-D GRIN backplane with a cylindrical electric field that may enable omni-directional signal routing;

FIG. 6 illustrates example distributions of nanoparticles within a GRIN backplane response to creation of an electric field;

FIG. 7 illustrates an example system to fabricate a GRIN backplane configured to employ an optical effect to direct an optical communication signal within the GRIN backplane;

FIG. 8 illustrates a general purpose computing device, which may be used in connection with fabrication of a GRIN backplane configured to employ an optical effect to direct an optical communication signal within the GRIN backplane;

FIG. 9 is a flow diagram illustrating an example method to fabricate a GRIN backplane configured to employ an optical effect to direct an optical communication signal within the GRIN backplane that may be performed or otherwise controlled by a computing device such as the computing device in FIG. 8; and

FIG. 10 illustrates a block diagram of an example computer program product, all arranged in accordance with at least some embodiments described herein.

### DETAILED DESCRIPTION

In the following detailed description, reference is made to the, accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, inter alia, to methods, apparatus, systems, devices, and/or computer program products related to employment of an optical effect to direct an optical communication signal within a gradient index (GRIN) backplane.

Briefly stated, technologies are generally described to employ an optical effect, such as Pockels effect, to direct an optical communication signal within a GRIN backplane electric field may be created between two or more electrodes located on different surfaces of the. GRIN backplane in response to an application of electrical excitation to at least one of the electrodes. The electric field may be configured to change an orientation of nanoparticles in at least a portion of GRIN material of the GRIN backplane so as to control a direction of one or more optical pathways within the GRIN backplane. Propagation of an optical communication signal between one or more components mounted on one or more surfaces of the GRIN backplane may be facilitated via the controlled direction of the optical pathways, which may enable control of routing, including switching, of the optical communication signal to a particular optical pathway.

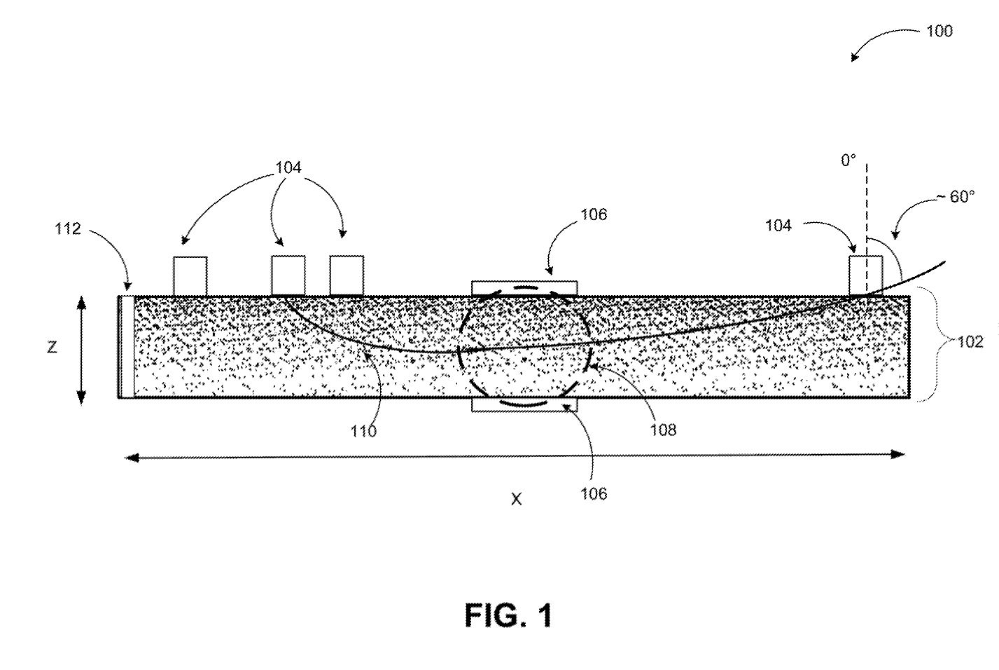

FIG. 1 illustrates a two-dimensional (2D) cross section of an example GRIN backplane configured to employ an optical effect to direct an optical communication signal within the GRIN backplane, arranged in accordance with at least some embodiments described herein

As shown in a diagram 100, a GRIN backplane 102 may include components 104 on one or more surfaces of the GRIN backplane 102, where two or more of the components 104 may be communicatively coupled through one or more optical pathways 110 within the GRIN backplane 102. The components 104 may be placed at locations along the one or more surfaces of the GRIN backplane 102 based on an approximate angle of incidence for the optical pathways 110 between the communicatively coupled components. The components 104 may farther be placed at locations along the surfaces of the GRIN backplane 102 to enable optical communication signals to be projected front an optical interface 112 and to arrive at the components 104. The components 104 may be enabled to project and/or receive optical communication signals via the optical pathways 110 within the GRIN backplane 102. Examples of the components 104 may include, but are not limited to, optical receivers, optical transmitters, optical sensors, and/or others. The GRIN backplane 102 may also include two or more electrodes 106 mounted on opposite surfaces of the GRIN backplane 102, where the electrodes 106 may be configured to create an electric field 108 between the opposite surfaces of the GRIN backplane in response to application of an electrical excitation to the electrodes 106.

The GRIN backplane 102 may comprise at least one sheet of planarly formed GRIN material that has at least one refractive index that varies (such as nonlinear, linear, geometric, arbitrary, exponential, formulaic and/or other type of variation or combination thereof) along at least one of orthogonal x, y, and z axes of the GRIN material. For purposes of brevity, the variation of the at least one refractive index of the GRIN material will be described herein in terms of non-linear variation, and it is understood that the other types of variation are possible within the scope of this disclosure.

The optical pathways 110 within the GRIN material may be configured based on the non-linear variation of the at least one refractive index. For example, when the optical communication signals are projected from one or more components 104 to one or more other components or from the one or more components 104 to an optical interface 112, the refractive index that non-linearly varies may be present along the z axis, and a substantially constant refractive index may be present along the x and y axes. Consequently, the direction of the optical pathway may be based on the gradient in the z axis. The thickness of the z axis may range from microns to several millimeters, and the range of refractive gradient index from low to high may be from about 0.02 to about 0.4, for example. In another example, when the optical communication signals are projected from the components 104 to the optical interface 112, the refractive index that non-linearly varies may be present along the x, y, and, z axes. Consequently, the direction of the optical pathway may be based on the gradient in the x, y, and z axes.

Forming a non-linear refractive index gradient across a backplane may enable reception and intrinsic, rerouting of optical communication signals dependent on the optical communication signals' location of incidence. The shape of the gradient index variation may be used to determine the reception and intrinsic rerouting functions. Furthermore, the non-linear refractive indices of the GRIN backplane may enable optical communication signals directed to different components 104 to cross each other without interference, and may enable two or more optical communication signals directed to different components 104 to be projected from a single emanation point, such as the optical interface 112.

The optical communication signals may include a laser beam, an infrared beam, a visible light beam, or other optical communication signals. The optical communication signals may not be internally reflected multiple times as they are routed. Instead, the optical communication signals may travel directly along the same pathway in both directions of optical communication signal transmission. The optical communication signals may turn into materials of relatively higher refractive index and may turn away from those with relatively lower refractive index due to phase velocity effects. As a result of the composition of the GRIN backplane 102, the optical communication signals projected close to the top surface (relatively higher refractive index) may be rapidly bent, and the optical communication signals projected further away closer to the bottom surface (relatively lower refractive index) may be bent slowly.

The GRIN material may be formed from two or more parallel layers of distinct refractive indices in a uniform progression from a relatively higher refractive index to a relatively lower refractive index. The parallel layers may be in a parallel orientation with reference to each other and in a diagonal orientation to the x, y, and z axes of the GRIN material The parallel layers may further have a uniform dipole orientation. In one embodiment, the GRIN material may be composed of one of poly(methylmethacrylate), perfluorinated polymers, cyclo olefin polymers, polystilfones, sulfonated polystyrene, silica glass with gradient varying additions such as boron, or fluoride glasses, each in a substantially amorphous state. Other materials may also be used for the GRIN material. The GRIN backplane 102 may be formed by layering the GRIN material of incrementally reduced refractive index over relatively higher refractive index material, heat diffusion of multiple layers, diffusion controlled chemical reaction, chemical vapor deposition (CVD), cross-linking, partial polymerization, ion exchange, ion stuffing directional solidification, and/or other techniques. In another embodiment, the GRIN material may be composed of a native ferroelectric polymer. Examples of native ferroelectric polymers may include Polyvinylidene fluoride (PVDF)[2,3,4], which possesses a useful optical communication signal transmission spectrum and low refractive index, and PVDF tri-fluoroethylene (Pvdf-TrFE). The GRIN material composed of these native ferroelectric polymers may be formed in a directional electric field to produce a uniform dipole orientation in the GRIN material. A layer of conductive traces may further be placed on at least one surface of the GRIN material and/or a combination layer of conductive traces and GRIN material may be formed to provide power to the components 104 and/or to other components affixed to or included in the GRIN backplane 102. For example, a copper sheet may be adhered or deposited to a surface of the GRIN material to act as the layer of conductive traces.

The GRIN backplane 102 may be partially or entirely sensitized to employ the optical effect to direct optical communication signals within the GRIN backplane. The GRIN backplane may be sensitized by using the GRIN material formed from the native ferroelectric polymers as discussed above, poling the GRIN material during curing, and/or by injecting nanoparticles into the GRIN material. The GRIN material may be poled during curing to produce a non-centro-symmetric ferroelectric polymer structure that is susceptible to the optical effect. The GRIN material may be poled by doping the material with dipole additions and curing the material under a directional electric field to produce a uniform dipole orientation in the GRIN material. A GRIN material composed of polyvinylidene fluoride (PVDF) may be relatively more reliable if the poling approach is used to increase susceptibility to the optical effect, as PVDF possesses a strong response and also properties from which to construct a matrix for the GRIN backplane 102 itself. These properties may include transparency in appropriate wavelengths, low refractive index, strength, and thermal stability, for example. Overall, use of PVDF may simplify manufacture and confer several other material property benefits to the GRIN backplane 102. Furthermore, the electrodes 106 may be mounted on the surfaces of the GRIN backplane 102 prior to final curing and used to pole the GRIN material at an elevated temperature ensuring formation of susceptible regions of the GRIN material in the needed region and further simplifying manufacture.

In another embodiment, at least a portion of the GRIN material may be injected with nanoparticles, such as a column of the GRIN material or an entirety of the GRIN material, to increase the GRIN material's susceptibility to the optical effect. The nanoparticles injected may be non-electro-optic nanoparticles and/or electro-optic nanoparticles, where the electro-optic nanoparticles may include non-centrosymmetric ceramic nanoparticles with ferroelectric properties. The nanoparticles may be approximately about 5 to 50 nanometers (nm) in diameter, and a concentration of the nanoparticles within GRIN material may be based on refractive indices of the nanoparticles. In a further embodiment, both the GRIN material may be formed from the native ferroelectric polymers or poled during curing and nanoparticles may be injected into the GRIN material to provide increased susceptibility to the optical effect,

The GRIN backplane 102 may then be configured to employ the optical effect to direct the optical communication signals within the GRIN backplane 102. The optical effect may be Pockels effect, for example, caused by a ferroelectric response to an applied electric field, where ferroelectric properties may be induced into a portion or an entirety of the GRIN backplane 102 during the formation of the GRIN material, as discussed above. The Pockels effect may enable a variation of a refractive index of the GRIN backplane 102 that is linear to the applied electric field, such as the electric field 108. The electric field 108 may be created between the electrodes 106 located on at least one surface of the GRIN backplane 102, in response to an application of an electrical excitation to at least one of the electrodes 106, such as application of electrical excitation to two electrodes located on opposite surfaces of the GRIN backplane 102, application of electrical excitation to one electrode of the GRIN backplane (with the electrode on an opposite surface of the GRIN backplane being grounded), or application of electrical excitation to two electrodes located on the same surface of the GRIN backplane 102, or application of electrical excitation in some other manner. The variation and/or maintenance of a particular refractive index of the GRIN backplane 102 may be controlled by a polarity and a magnitude of the electrical excitation. The electrical excitation may be an application of voltage and/or current. For example, for a GRIN backplane comprising GRIN material formed from native ferroelectric polymers, a voltage range from 0 to ±3000 volts (V) may be applied. In another example, for a GRIN backplane comprising GRIN material injected with electro-optic nanoparticles, ±0.5-10 kilovolts (kV) may be applied. The voltage required is dependent on the thickness of the backplane, and the material used. The electric field 108 may be configured to change an orientation of the nanoparticles in the GRIN material so as to control a direction of the optical pathways 110 within the GRIN backplane. Propagation of an optical communication signal between the components via the controlled direction of the one or more optical pathways 110 may then be facilitated. Propagation of the optical communication signal may include changing the electric field 108 to change the direction of the optical pathways 110 to control routing, including switching, of the optical communication signal to a particular optical pathway. For example, by changing a strength of the electrical excitation applied, and therefore the strength of the electric field, the optical communication signal may be deflected at a greater or lesser degree upon entry and exit of the electric field because the degree of deflection may be based at least in part on a strength of the electric field. The degree of the deflection may then affect which of the components 104 on the one or more surfaces of the GRIN backplane 102 the optical communication signal may arrive at.

The electrodes 106 may be positioned at a location on the opposite surfaces of the GRIN backplane based on dimensions of the GRIN backplane 102 and/or a location of the communicatively coupled components. In some embodiments, the electrodes 106 may be placed on the same surface and/or on orthogonal surfaces of the GRIN backplane 102, thereby providing an electric field that is different in some respects (e.g., strength, shape, extent, etc.) as compared to an electric field that is generated from electrodes 106 located on opposite surfaces of the GRIN backplane 102. For purposes of clarity and brevity, the various embodiments will be described herein in the context of electrodes being located on opposite surfaces of a GRIN backplane, and it is understood that embodiments in which electrodes are placed at other surface location(s) of a GRIN backplane are within the scope of this disclosure.

The GRIN material between these electrodes 106 may respond variably to the polarity and magnitude of the electrical excitation across the electrodes 106 enabling optical signal redirection between the communicatively coupled components. The location may be further chosen such that achievable redirections can send the optical signals to a number of the components. The electric field 108 created by the electrodes 106 may be somewhat similar to a capacitor with straight walls and a cross-sectional shape of the electrodes 106. Shapes and/or sizes of the electrodes 106 may be based on the direction of the optical pathways 110 between the communicatively coupled components, with the shapes including squares, rectangles, circles, and triangles and/or other shape(s) or combination(s) thereof. In some examples, square and/or rectangular electrodes may be used to route light in two dimensions rather than one dimension. In other examples, virtual prisms may be created by alternating large-small electrode combinations to create triangular field shapes. In further examples, a cylindrical field region created from circular electrodes may be used to enable omni-directional beam routing. Enhanced beam steering effects may also be generated by changing the size and shape of the electrodes relative to one another. These effects can be used to create a gradient of field intensity across the GRIN backplane, resulting in different refractive index responses from the GRIN backplane and/or the nanoparticles.

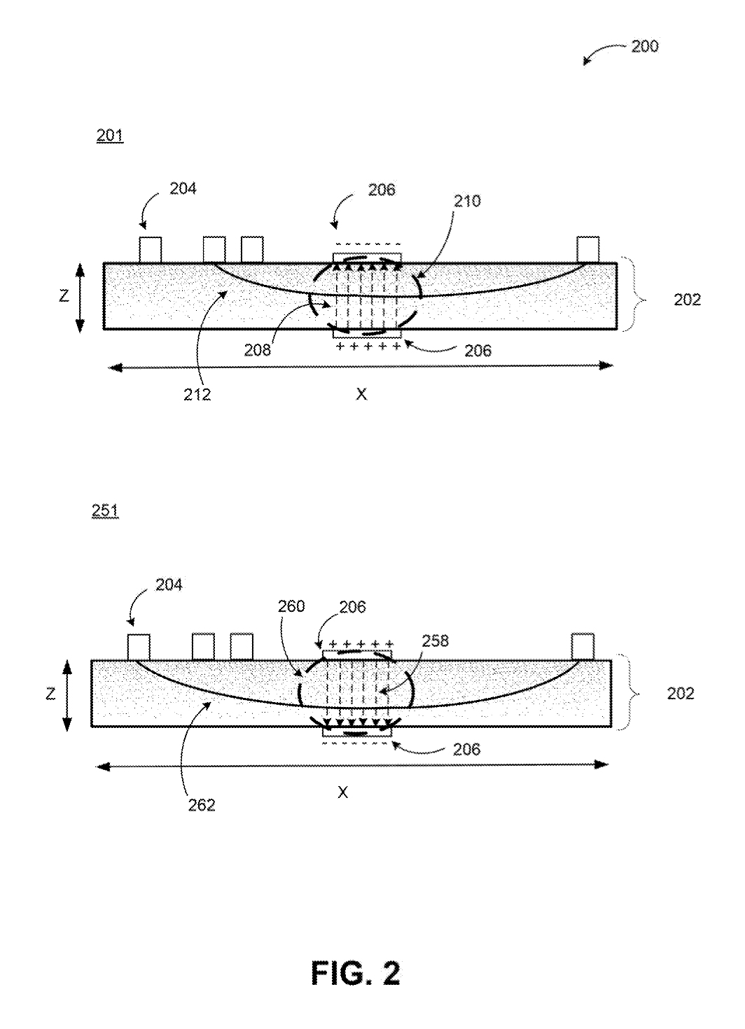

FIG. 2 illustrates example configurations of an electric field that may be established within a GRIN backplane, arranged in accordance with at least some embodiments described herein.

As shown in a diagram 200, one or more configurations, 201 and 251, of an electric field 208, 258 may be respectively formed within a GRIN backplane 202. As discussed previously, the GRIN backplane 202 may be comprised of at least one sheet of GRIN material, where the GRIN material may include nanoparticles in at least a portion of the GRIN material. The GRIN backplane 202 may further include one or more components 204 located on a surface of the GRIN backplane 202 and two or more electrodes 206 located on different and/or opposite surfaces of the GRIN backplane 202. An electric field 208, 258 may be created between the electrodes 206 in response to an application of a voltage and/or current to at least one of the electrodes 206. A polarity of the electrodes 206 in association with the GRIN backplane 202 may be determined by a direction of the electric field 208.

In configuration 201, the electric, field 208 may be formed in a direction from a bottom surface of the GRIN backplane 202 to a top surface of the GRIN backplane. By maintaining the polarity of the electrodes 206 in association with the GRIN backplane 202, as illustrated in the configuration 201, application of the voltage and/or current, may increase a refractive index of a field-affected GRIN backplane region 210. As a result, an optical communication signal propagating down into the GRIN backplane 202 via an optical pathway 212 may be deflected up at a slightly greater degree upon entering the field-affected GRIN backplane region 210. Furthermore, the optical communication signal may be deflected up at a slightly greater degree upon exiting the field-affected GRIN backplane region 210. The increase in the refractive index of the field-affected GRIN backplane region 210 may result in a reduction of distance traveled by the optical communication signal via the optical pathway 212 due to the greater degree in deflection.

In configuration 251, the electric field 258 may be formed in a direction from a top surface of the GRIN backplane 202 to a bottom surface of the GRIN backplane. By reversing the polarity of the electrodes 206 in association with the GRIN backplane 202, as illustrated in the configuration 251, application of the voltage and/or current, may decrease a refractive index of a field-affected GRIN backplane region 260. As a result, an optical communication signal propagating down into the GRIN backplane 202 via an optical pathway 262 may be deflected at a slightly lesser degree in the field-affected GRIN backplane region 260. Furthermore, the optical communication signal may be deflected at a slightly lesser degree upon exiting the field-affected GRIN backplane region 210. Overall, the decrease in the refractive index of the field-affected GRIN backplane region 260 may result in a lengthening; of distance traveled by the optical communication signal via, the optical pathway 262 due to the lesser degree of deflection.

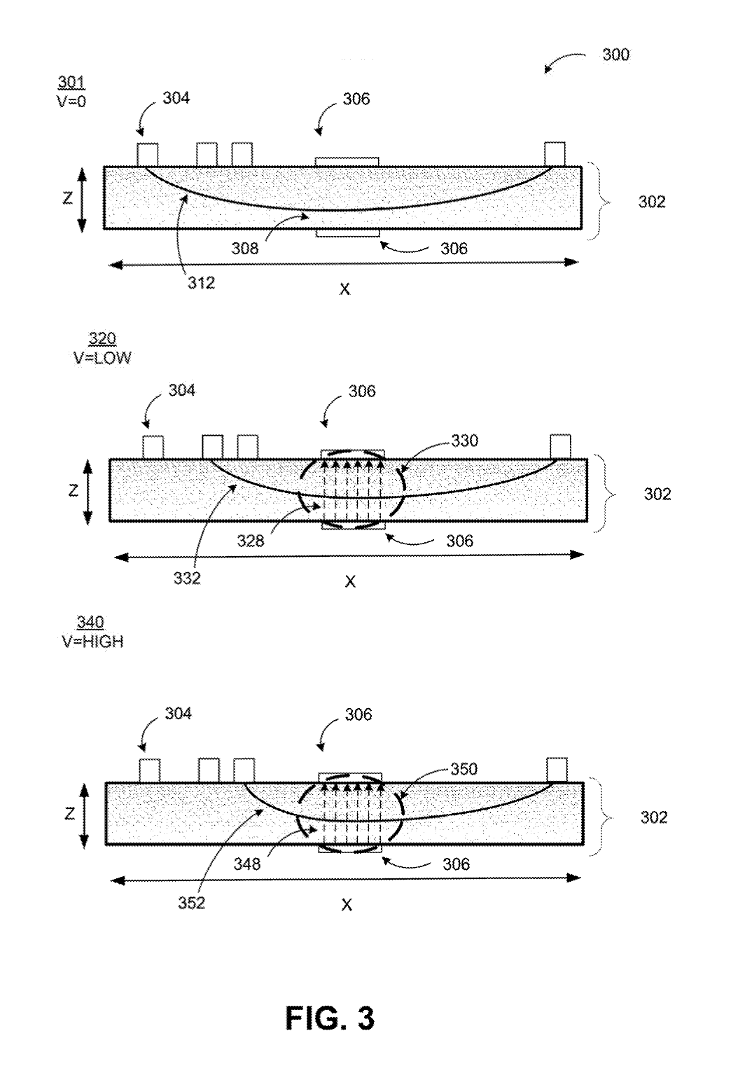

FIG. 3 illustrates an example voltage effect on an optical communication signal routing behavior within a GRIN backplane, arranged in accordance with at least some embodiments described herein.

As shown in a diagram 300, a GRIN backplane 302 may include one or more components 304 located on a surface of the GRIN backplane 302 and two or more electrodes 306 located on different and/or opposite surfaces of the GRIN backplane 202, hi configuration 301, no electrical excitation, such as a voltage, is applied to at least one of the electrodes 306 and therefore, no electric field is formed. As a result, an optical communication signal propagating down into the GRIN backplane 302 via an optical pathway 312 travels a route through the GRIN backplane to a receiving component dependent on the optical communication signals' location of incidence. The optical communication signal may experience little or no deflection effects upon entering and exiting the region 308 between the electrodes 306.

In configuration 320, a low electrical excitation, such as a low voltage, is applied to at least one of the electrodes 306. In response to the low voltage applied, an electric field 328 is created in a direction from a bottom surface of the GRIN backplane 202 to a top surface of the GRIN backplane between the electrodes 306. By maintaining a polarity of the electrodes 306 in association with the GRIN backplane 202 as illustrated in the configuration 320, application of the voltage may increase a refractive index of a field-affected GRIN backplane region 330. As a result, an optical communication signal propagating down into the GRIN backplane 302 via an optical pathway 332 may be deflected up at a slightly greater degree upon entering the field-affected GRIN backplane region 330. Furthermore, the optical communication signal may be deflected up at a greater degree upon exiting the field-affected GRIN backplane region 330. The increase in the refractive index of the field-affected GRIN backplane region 330 may result in a reduction of distance traveled by the optical communication signal via the optical pathway 332 due to the slightly greater degree of deflection upon entry and exit of the field-affected GRIN backplane region 330, and hence the optical communication signal in configuration 320 may arrive at a different destination (e.g. a different component) on the surface of the GRIN backplane 302 as compared to configuration 301).

In configuration 340, a high electrical excitation, such as a high voltage The voltage in configuration 301 is 0V or very close to it The “low” voltage for 320, and the “high” voltage for 340, and any configurations in between may range from “low”: less than ±250V, to “high”: greater than ±250V but less than 10 kV. There can be as many voltage configurations in this range as there are light destinations, is applied to at least one of the electrodes 306. In response to the high voltage applied, an electric field 348 is formed in a direction from a bottom surface of the GRIN backplane 202 to a top surface of the GRIN backplane between the electrodes 306. Similar to configuration 320, by maintaining the polarity of the electrodes 306 in association with the GRIN backplane 202 as illustrated, application of a voltage may increase a refractive index of a field-affected GRIN backplane region 350. By increasing a strength of the voltage to a high voltage, the strength of the electric field 348 may be accordingly be increased and the refractive index may be even further increased in the field-affected GRIN backplane region 350. As a result, an optical communication signal propagating down into the GRIN backplane 302 via an optical pathway 352 may be deflected up at an even greater degree in the field-affected GRIN backplane region 350. Furthermore, the optical communication signal may be deflected up at an even greater degree upon exiting the field-affected GRIN backplane region 350. In comparison to configuration 320, the greater increase in the refractive index of the field-affected GRIN backplane region 350 may result in a further reduction of distance traveled by the optical communication signal via, the optical pathway 352 due to the even greater degree of deflection, and hence the optical communication signal in configuration 350 may arrive at a different destination (e.g. a different component) on the surface of the GRIN backplane 302 (as compared to configurations 301 and 320). Therefore as demonstrated in configurations 301, 320, and 340, the application of the electrical excitation to at least one of the electrodes 306 (to generate and/or change the electrical field) can provide routing (including switching) capability to control the direction and destination of the various optical pathways.

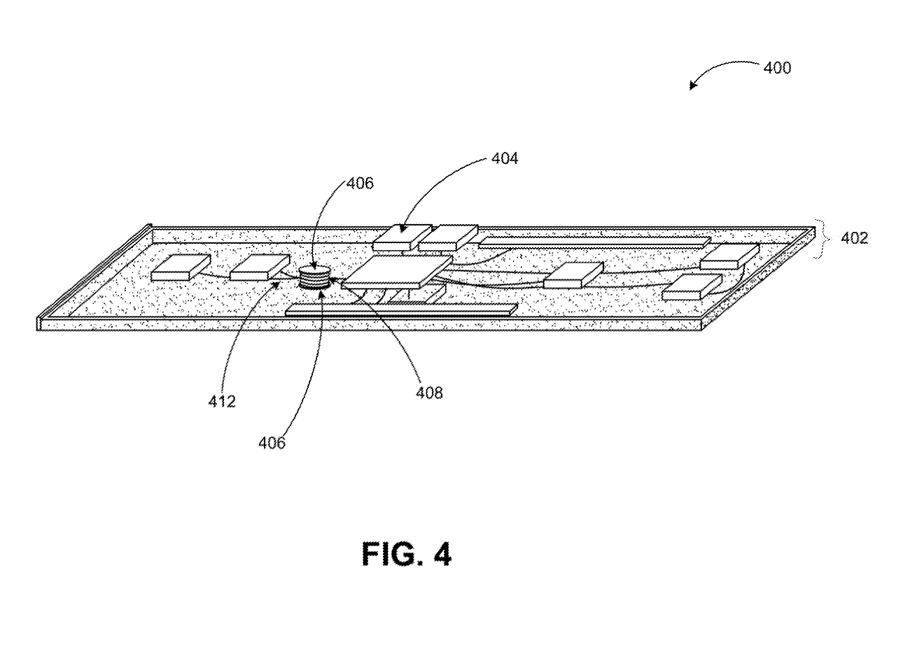

FIG. 4 illustrates an example three-dimensional (3D) GRIN backplane configured to employ an optical effect to direct an optical communication signal within the GRIN backplane, arranged in accordance with at least some embodiments described herein.

As shown in a diagram 400, a GRIN backplane 402, comprised of at least one sheet of GRIN material and a multitude of nanoparticles in at least a portion of the GRIN material, may include one or more components 404 located on a surface of the GRIN backplane 402 and two or more circular-shaped electrodes 406 located on different and/or opposite surfaces of the GRIN backplane 402. An electric field 408 may be formed between the electrodes 406 in response to an application of a voltage and/or current to at least one of the electrodes 406. The electrodes 406 may be positioned at a location on the different and/or opposite surfaces of the GRIN backplane 402 based on dimensions of the GRIN backplane 402 and/or a location of the communicatively coupled components. The GRIN material between these electrodes 406 may respond variably to the voltage and/or current polarity and magnitude across the electrodes 406 enabling optical signal redirection between the communicatively coupled components. The location may be further chosen such that achievable redirections can send the optical signals to a number of the components.

The electric field 408 created by the electrodes 406 may be similar to a capacitor with straight walls and a cross-sectional shape of the electrodes 406. Shapes and/or sizes of the electrodes 406 may be based on the direction of the one or more optical pathways 412 between the communicatively coupled components, the shapes including squares, rectangles, circles, and triangles and/or other shapes or combinations thereof dependent on the direction, contour, strength, etc. of the intended electrical field. For example, as illustrated in FIG. 4, application of a voltage and/or current to the circular-shaped electrodes 406 may form an electric field 408 with straight walls and a cross-section of a circle. The electric field 408 may be configured to change an orientation of the nanoparticles within the GRIN material so as to control a direction of one or more optical pathways within the GRIN material comprising the GRIN backplane 402. Propagation of an optical communication signal between the components 404 on the surfaces of the GRIN backplane 402 may then be facilitated via the controlled direction of the optical pathways 412, which may enable control of routing, including switching, of the optical communication signal to a particular optical pathway.

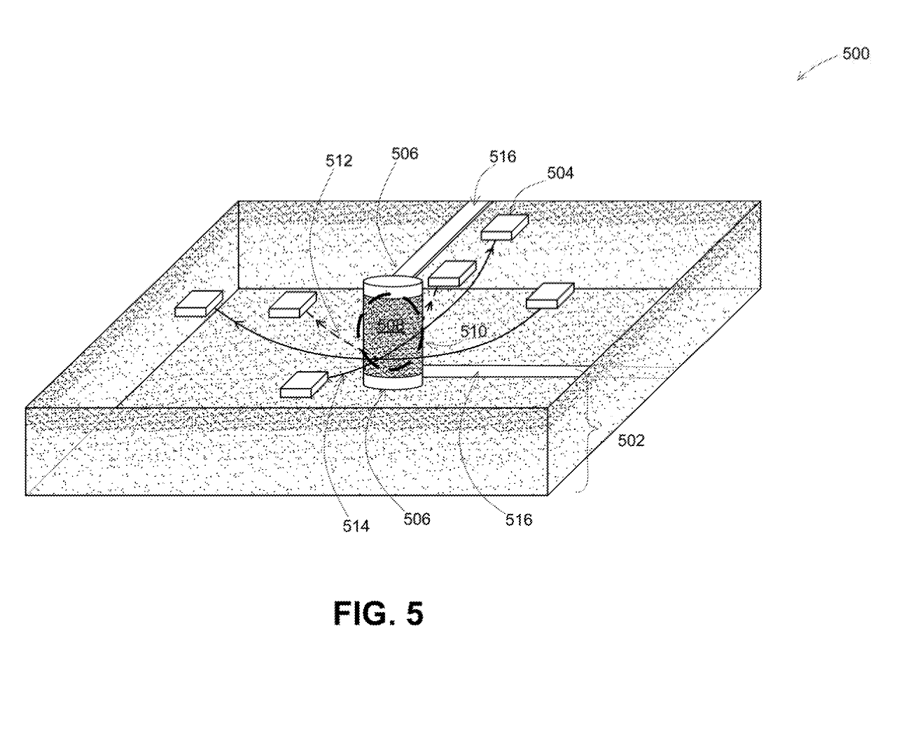

FIG. 5 illustrates an example 3-D GRIN backplane with a cylindrical electric field that may enable omni-directional signal routing, arranged in accordance with at least some embodiments described herein,

As shown in a diagram 500, a GRIN backplane 502, comprised of at least one sheet of GRIN material and a multitude of nanoparticles in at least a portion of the GRIN material, may include one or more components 504 located on a surface of the GRIN backplane 502 and two or more circular-shaped electrodes 506 located on different and/or opposite surfaces of the GRIN backplane 502. The electrodes 506 may be etched in copper, but the etched leads 516 to each electrode 506 may not run parallel. A cylindrical electric field 508 may be formed between the electrodes 506 in response to an application of a voltage and/or current to at least one of the electrodes 506. By employing circularly-shaped electrodes 506, propagation of optical communication signals via one or more optical pathways through the cylindrical electric field 508 may enable omni-directional signal routing, as a parallel travel distance may be controlled for optical communication signals from any direction without any lateral refraction.

For example, when high voltage is applied, a refractive index of a field-affected GRIN backplane region 510 may be increased. As a result, an optical communication signal propagating down into the GRIN backplane 502 via an optical pathway 512 may be deflected up at a greater degree upon entering and exiting the field-affected GRIN backplane region 510. Overall, the increase in the refractive index of the field-affected GRIN backplane region 510 may result in a reduction of distance traveled by the optical communication signal via the optical pathway 512 due to the greater degree of deflection. As a comparison, if no voltage is applied and therefore no electric field is created, an optical communication signal propagating down into the GRIN backplane 502 via an optical pathway 514 travels a route through the GRIN backplane to a receiving component experiencing no effects from the region between the electrodes 306. Instead, the route may be dependent on the optical communication signals' location of incidence.

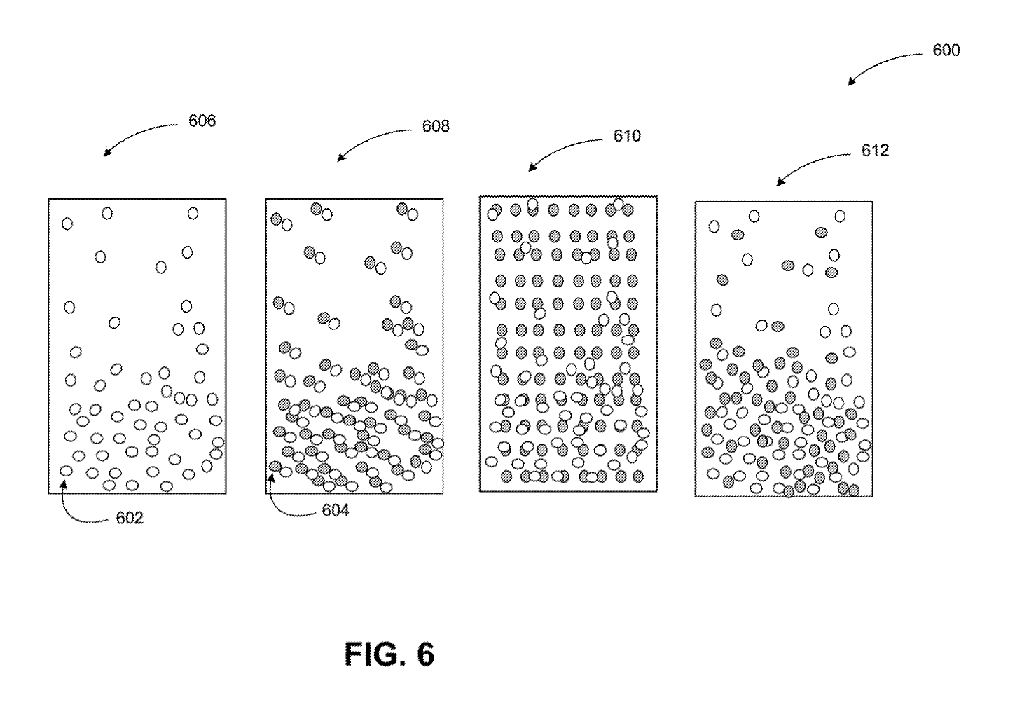

FIG. 6 illustrates example distributions of nanoparticles within a GRIN backplane in response to creation of an electric field, arranged in accordance with at least some embodiments described herein.

As shown in a diagram 600, a portion of GRIN material used to form a GRIN backplane may include nanoparticles. The portion of GRIN material including nanoparticles may include a column of the GRIN material or an entirety of the GRIN material. The nanoparticles may include non-electro-optic nanoparticles 602 and/or electro-optic nanoparticles 604, where the electro-optic nanoparticles 604 may include non-centrosymmetric ceramic nanoparticles with ferroelectric properties. A concentration of the nanoparticles within the GRIN material may be based on refractive indices of the nanoparticles.

An orientation of the nanoparticles may be changed in response to an electric field created by at least one (including two or more) electrodes located on different surfaces of the GRIN backplane, where the changed orientation of the nanoparticles results in the change in the at least one refractive index of the GRIN material. The change in the at least one refractive index may further result in a change of an optical pathway within the GRIN backplane, which may provide a routing capability, including switching capability, in the GRIN material for an optical signal that propagates along the optical pathway. Orientation 606 illustrates an example gradient of the non-electro-optic nanoparticles 602 formed in response to an electric field. Examples of nanoparticle orientations 608, 610 and 612 in response creation of the electric field created are further illustrated in FIG. 6.

Dependent on a polarity and/or strength of an electrical excitation applied to at least one of the electrodes to form the electric field, the orientations 608, 610, and 612 may raise or lower the refractive index of a field-affected GRIN backplane region. In orientation 608, gradients of the non-electro-optic nanoparticles 602 and the electro-optic nanoparticles 604 may be matched enabling a shape of the refractive index gradient in the field-affected GRIN backplane region to persist. In orientation 610, a gradient of the electro-optic nanoparticles 604 may be evenly distributed over the gradient of the non-electro-optic nanoparticles 602, which may slightly flatten the shape of the refractive index gradient in the field-affected GRIN backplane region. In orientation 612, gradients of the non-electro-optic nanoparticles 602 and the electro-optic nanoparticles 604 may be different, which may steepen or flatten the shape of the refractive index gradient in the field-affected GRIN backplane region. As the shape of the gradient that is created in the field-affected GRIN backplane region steepens, a travel distance for optical communication signals propagated through the field-affected GRIN backplane region via one or more optical pathways may be reduced.

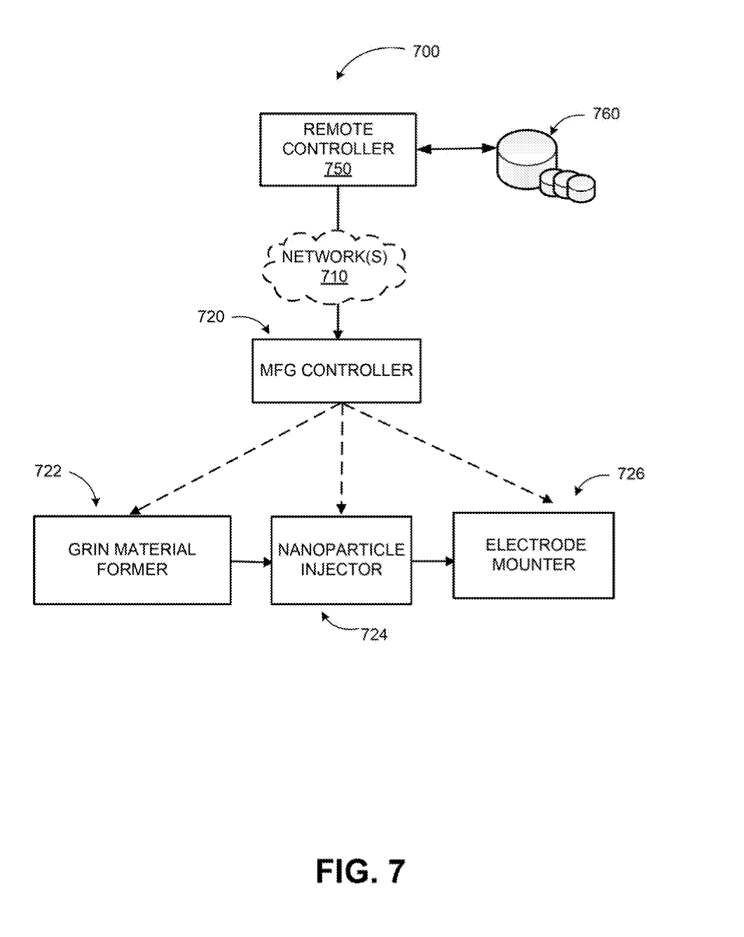

FIG. 7 illustrates an example system to fabricate a GRIN backplane configured to employ an optical effect to direct an optical communication signal within the GRIN backplane, arranged in accordance with at least some embodiments described herein.

System 700 may include a manufacturing controller 720, a GRIN material former 722, a nanoparticle injector 724, and an electrode mounter 726. The manufacturing controller 720 may be operated by human control or may be configured for automatic operation, or may be directed by a remote controller 750 through at least one network (for example, via network 710). Data associated with controlling the different processes of GRIN backplane fabrication may be stored at and/or received from data stores 760.

The manufacturing controller 720 may include or control a fabrication module configured to form at least one sheet of GRIN material, where at least a portion of the at least one sheet of GRIN material is injected with nanoparticles and an assembly module configured to mount two or more electrodes on different surfaces of the GRIN backplane. In one embodiment, such a fabrication module may comprise the GRIN material former 722 and the nanoparticle injector 724, and such an assembly module may comprise the electrode mounter 726 shown in FIG. 7.

The GRIN material former 722 may form at least one sheet of GRIN material using two or more parallel layers of distinct refractive indices in a uniform progression from a relatively higher refractive index to a relatively lower refractive index. The parallel layers may be in a parallel orientation with reference to each other and in a diagonal orientation to the x, y, and z axes of the sheet of GRIN material. The parallel layers may further have a uniform dipole orientation. The GRIN material may be composed of poly(methyl methacrylate), perfluorinated polymers, cyclo-olefin polymers, polysulfones, sulfonated polystyrene, silica glass with gradient varying additions such as boron, or fluoride glasses, each in a substantially amorphous state, or may use other materials and combinations thereof for the GRIN material. A GRIN backplane may be formed by layering one or more sheets of the GRIN material of incrementally reduced refractive index over relatively higher refractive index material, heat diffusion of multiple layers, diffusion controlled chemical reaction, chemical vapor deposition (CVD), cross-linking, partial polymerization, ion exchange, ion stuffing directional solidification, and/or other techniques. In another embodiment, the GRIN material may he composed of a native ferroelectric polymer, such as Polyvinylidene fluoride (PVDF)[2,3,4], and PVDF tri-fluoroethylene (Pvdf-TrFE). The GRIN material composed of the native ferroelectric polymer may be formed in a directional electric field to produce uniform dipole orientation in the GRIN material. In yet another embodiment, the sheet of GRIN material may be poled during curing to produce a non-centrosymmetric ferroelectric polymer structure.

The nanoparticle injector 724 may inject or otherwise place a multitude of nanoparticles into at least a portion of the sheet of GRIN material, where the portion may include a column or an entirety of the sheet of GRIN material for example. The nanoparticles may include non-electro-optic nanoparticles and/or electro-optic nanoparticles, where the electro-optic nanoparticles may include non-centrosymmetric ceramic nanoparticles with ferroelectric properties. A concentration of the nanoparticles injected within the sheet of GRIN material may be based on refractive indices of the nanoparticles.

Following injection of the nanoparticles the electrode mounter 726 may position two or more electrodes on different surfaces, such as opposite surfaces, on the sheet of GRIN material. The electrodes may be positioned based on dimensions of the sheet of GRIN material and/or a location of the communicatively coupled components on the surfaces of the sheet of GRIN material. Once mounted, an electric field may be formed between the electrodes by application of a voltage and/or current to at least one of the electrodes. The electric field may be configured to change an orientation of the injected nanoparticles within the sheet of GRIN material so as to control a direction of one or more optical pathways within the sheet of GRIN material. Propagation of an optical communication signal between one or more components mounted on one or more surfaces of the sheet GRIN material may then be facilitated via the controlled direction of the optical pathways, which may enable control of routing., including switching, of the optical communication signal to a particular optical pathway.

The examples in FIGS. 1 through 7 have been described using specific configurations and processes in which employment of an optical effect to direct an optical communication signal within a GRIN backplane may be implemented. Embodiments for employment of an optical effect to direct an optical communication signal within a GRIN backplane are not limited to the configurations and processes according to these examples.

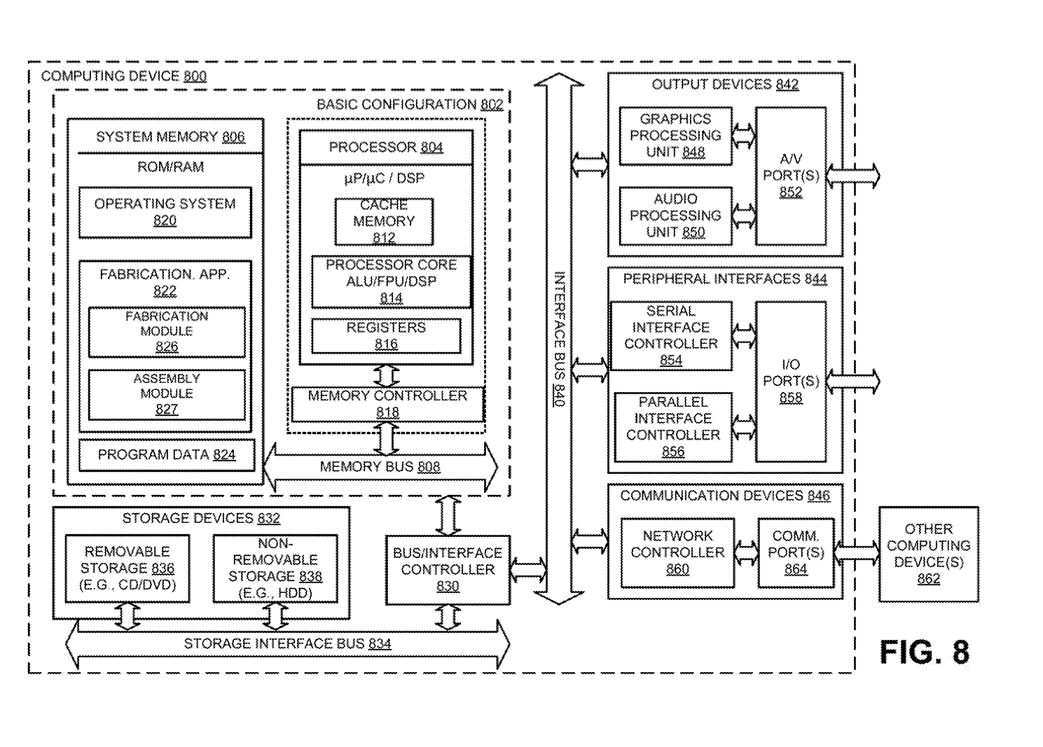

FIG. 8 illustrates a general purpose computing device, which may be used in connection with fabrication of a GRIN backplane configured to employ an optical effect to direct an optical communication signal within the GRIN backplane, arranged in accordance with at least some embodiments described herein.

For example, the computing device 800 may be used to manage or otherwise control a fabrication process of a GRIN backplane as described herein. In an example basic configuration 802, the computing device 800 may include one or more processors 804 and a system memory 806. A memory bus 808 may be used for communicating between the processor 804 and the system memory 806. The basic configuration 802 is illustrated in FIG. 8 by those Components within the inner dashed line.

Depending on the desired configuration, the processor 804 may be of any type, including but not limited to a microprocessor (μP), a microcontroller (μC), a digital signal processor (DSP), or any combination thereof. The processor 804 may include one more levels of caching, such as a level cache memory 812, a processor core 814, and registers 816. The example processor core 814 may include an arithmetic logic unit (ALU), a floating point unit (FPU), a digital signal processing core (DSP Core), or any combination thereof. An example memory controller 818 may also be used with the processor 804, or in some implementations the memory controller 818 may be an internal part of the processor 804.

Depending on the desired configuration, the system memory 806 may be of any type including but not, limited to volatile memory (such as RAM), non-volatile memory (such as ROM, flash memory, etc.) or any combination thereof. The system memory 806 may include an operating system 820, a fabrication application 822, and program data 824. The fabrication application 822 may include a fabrication module 826 and an assembly module 827 to fabricate and assemble the GRIN backplane configured to employ an optical effect to direct an optical communication signal within the GRIN backplane, as described herein. In some embodiments, one or more of the GRIN material former 722 and the nanoparticle injector 724 may be used to implement the fabrication module 826, and the electrode mounter 726 may be used to implement the assembly module 827.

The computing device 800 may have additional features or functionality, and additional interfaces to facilitate communications between the basic configuration 802 and any desired devices and interfaces. For example, a bus/interface controller 830 may be used to facilitate communications between the basic configuration $02 and one or more data storage devices 832 via a storage interface bus 834. The data storage devices 832 may be one or more removable storage devices 836, one or more non-removable storage devices 838, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSTDs), and tape drives to name a few. Example computer storage media may include volatile and nonvolatile, removable and non-removable media implemented in any method or technology for storage of information, such as computer readable instructions, data structures, program modules, or other data.

The system memory 806, the removable storage devices 836 and the non-removable storage devices 838 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 800. Any such computer storage media may be part of the computing device 800.

The computing device 800 may also include an interface bus 840 for facilitating communication from various interface devices (for example, one or more output devices 842, one or more peripheral interfaces 844, and one or more communication devices 846) to the basic configuration 802 via the bus/interface controller 830. Some of the example output devices 842 include a graphics processing unit 848 and an audio processing unit 850, which may be configured to communicate to various external devices such as a display or speakers via one or more A/V ports 852. One or more example peripheral interfaces 844 may include a serial interface controller 854 or as parallel interface controller 856, which may be configured to communicate with external devices such as input devices (for example, keyboard, mouse, pen, voice input device, touch input device, etc.) or other peripheral devices (for example, printer, scanner, etc.) via one or more I/O ports 858. An example communication device 846 includes a network controller 860, which may be arranged to facilitate communications with one or more other computing devices 862 over a network communication link via one or more communication ports 864. The one or more other computing devices 862 may include servers at datacenter, customer equipment, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 800 may be implemented as a part of a general purpose or specialized server, mainframe, or similar computer that includes any of the above functions. The computing device 800 may also be implemented as a personal computer including both laptop computer and non-laptop computer configurations.

Example embodiments may also include methods to employ an optical effect to direct an optical communication signal within the GRIN backplane. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be with a machine that performs a portion of the program. In other examples, the human interaction can be automated such as by pre-selected criteria that may be machine automated.

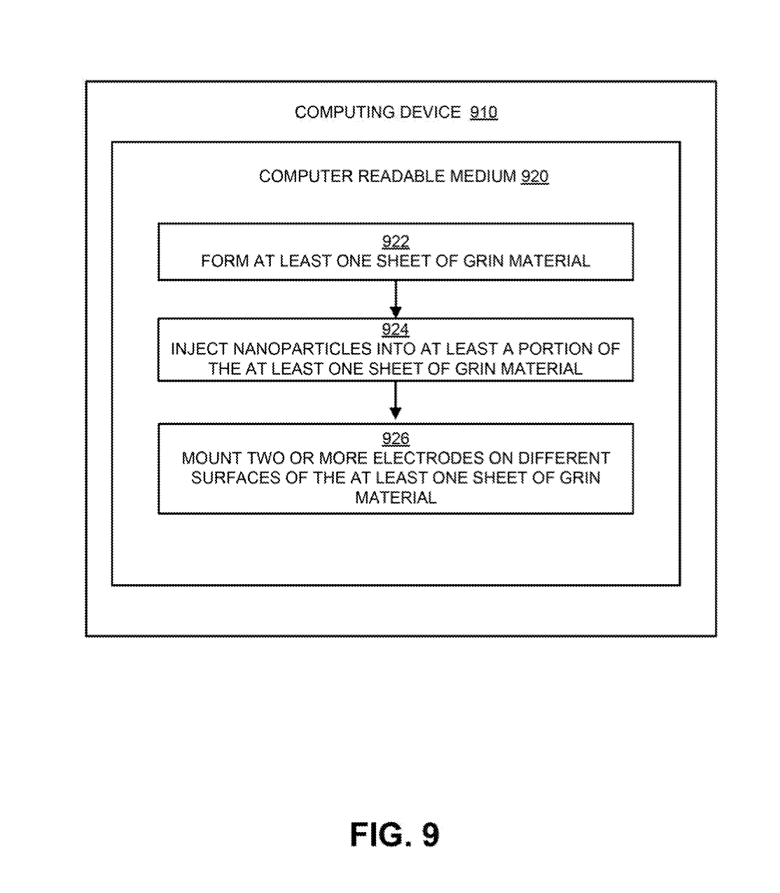

FIG. 9 is a flow diagram illustrating an example method to fabricate a GRIN backplane configured to employ an optical effect to direct an optical communication signal within the GRIN backplane that may be performed or otherwise controlled by a computing device such as the computing device in FIG. 8, arranged in accordance with at least some embodiments described herein.

Example methods may include one or more operations, functions or actions as illustrated by one or more of blocks 922, 924, and/or 926, and may in some embodiments be performed by a computing device such as the computing device 800 in FIG. 8. The operations described in the blocks 912-926 of one embodiment may also be stored as computer-executable instructions in a non-transitory computer-readable medium such as a computer-readable medium 920 of a computing device 910 and may be executable by one or more processors.

An example process to fabricate the GRIN backplane may begin with block 922, “FORM AT LEAST ONE SHEET OF GRIN MATERIAL,” where a GRIN material former (for example, the GRIN material former 722) may form at least one sheet of GRIN material that includes at least one refractive index that non-linearly varies (or otherwise varies) along at least one of the x, y, and/or z axes of the sheet, and at least one optical pathway in the GRIN material that may be configured to have a direction based on the non-linear variation of the at least one refractive index. The sheet of GRIN material may be formed from two or more parallel layers of distinct refractive indices in a uniform progression from a relatively higher refractive index to a relatively lower refractive index. The parallel layers may be in a parallel orientation with reference to each other and in a diagonal orientation to the x, y, and z axes of the sheet of GRIN material.

Block 922 may be followed by block 924, “INJECT NANOPARTICLES INTO AT LEAST A PORTION OF THE AT LEAST ONE SHEET OF GRIN MATERIAL,” where a nanoparticle injector (for example, the nanoparticle injector 724) may inject a multitude of nanoparticles into at least a portion of the at least one sheet of GRIN material, where the portion may include a column or an entirety of the sheet of GRIN material. The nanoparticles may include non-electro-optic nanoparticles and/or electro-optic nanoparticles, where the electro-optic nanoparticles may include non-centrosymmetric ceramic nanoparticles that have ferroelectric properties. A concentration of the nanoparticles injected within the sheet of GRIN material may be based on refractive indices of the nanoparticles.

Block 924 may be followed by block 926, “MOUNT TWO OR MORE ELECTRODES ON DIFFERENT SURFACES OF THE AT LEAST ONE SHEET OF GRIN MATERIAL,” where an electrode mounter (for example, the electrode mounter 726) may position two or more electrodes on different surfaces, such as opposite surfaces, of the at least one sheet of GRIN material. The electrodes may be positioned based on dimensions of the at least one sheet of GRIN material and/or a location of the communicatively coupled components on the surfaces of the at least one sheet of GRIN material. Once mounted, an electric field may be formed between the electrodes by application of a voltage and/or current to at least one of the electrodes. The electric field may be configured to change an orientation of the injected nanoparticles within the at least one sheet of GRIN material so as to control a direction of one or more optical pathways within the sheet of GRIN material. Propagation of an optical communication signal between one or more components mounted on one or more surfaces of the at least one sheet GRIN material may then be facilitated via the controlled direction of the optical pathways, which may enable control of routing, including switching, of the optical communication signal to a particular optical pathway.

The blocks included in the above described process are for illustration purposes. Fabrication of a GRIN backplane configured to employ an optical effect to direct an optical communication signal within the GRIN backplane may be implemented by similar processes with fewer or additional blocks. In some embodiments, the blocks may be performed in a different order. In some other embodiments, various blocks may be eliminated. In still other embodiments, various blocks may be divided into additional blocks, supplemented with other blocks, or combined together into fewer blocks.

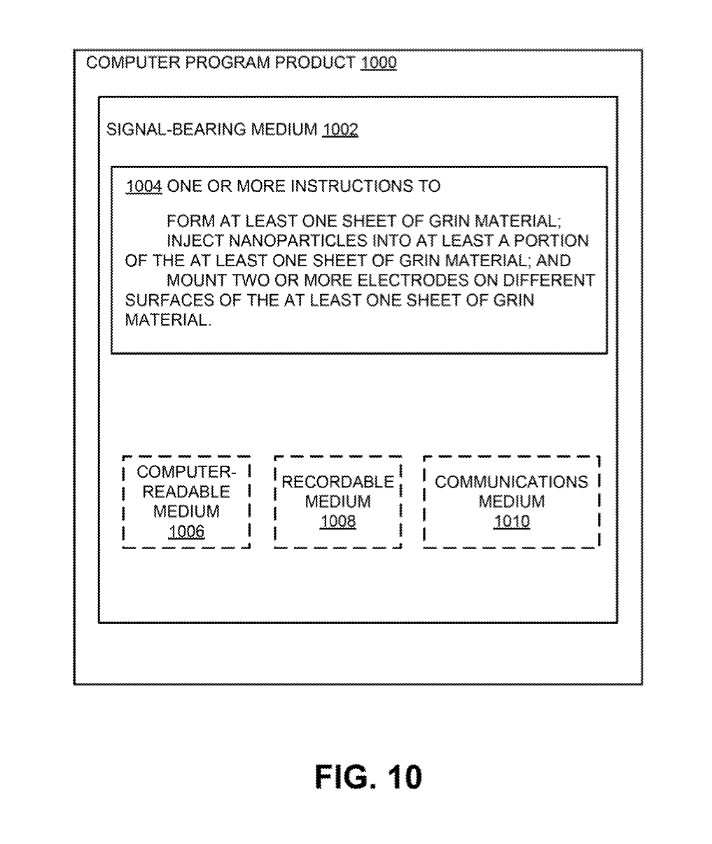

FIG. 10 illustrates a block diagram of an example computer program product, arranged in accordance with at least some embodiments described herein.

In some examples, as shown in FIG. 10, the computer program product 1000 may include a signal bearing medium 1002 that may also include one or more machine readable instructions 1004 that, in response to execution by, for example, a processor may provide the features and operations described herein. Thus, for example, referring to the processor 804 in FIG. 8, the fabrication application 822, the fabrication module 826, or the assembly module 827 may undertake one or more of the tasks shown in FIG. 10 in response to the instructions 1004 conveyed to the processor 804 from the medium 1002 to perform actions associated with fabrication of a GRIN backplane configured to employ an optical effect to direct an optical communication signal within the GRIN backplane, as described herein. Some of those instructions may be, for example, to form at least one sheet of GRIN material, inject nanoparticles into at least a portion of the at least one sheet of GRIN material, and mount two or more electrodes on different surfaces of the at least one sheet of GRIN material, according to some embodiments described herein.

In some implementations, the signal bearing medium 1002 depicted in FIG. 10 may encompass a computer-readable medium 1006, such as, but not limited to, a hard disk drive, a solid state drive, a Compact Disc (CD), a Digital Versatile Disk (DVD), a digital tape, memory, etc. In some implementations, the signal bearing medium 1002 may encompass a recordable medium 10010, such as, but not limited to, memory, read/write (R/W) CDs, R/W DVDs, etc. In some implementations, the signal bearing medium 1002 may encompass a communications medium 1010, such as, but not limited to, a digital and/or an analog communication medium (for example, a fiber optic cable, a waveguide, a wired communications link, a wireless communication link, etc.). Thus, for example, the program product 1000 may be conveyed to one or more modules of the processor 804 by an RF signal bearing medium, where the signal bearing medium 1002 is conveyed by the wireless communications medium 1010 (for example, a wireless communications medium conforming with the IEEE 802.11 standard).

According to some examples, gradient index (GRIN) backplanes are described. An example GRIN backplane may include a planarly formed GRIN material, where the GRIN material includes at least one refractive index that varies along orthogonal x, y, and/or z axes of the GRIN material. The example GRIN backplane may also include nanoparticles in at least a portion of the GRIN material, where a section of at least one optical pathway is formed in the portion of the GRIN material based on variation of the refractive index. The nanoparticles may enable the refractive index in the portion of the GRIN material to be changed in response to an electric field, where the change in the refractive index in response to the electric field results in a change in the section of the optical pathway in the portion of the GRIN material.

In other examples, the portion of the GRIN material may include a column alone the x, y, or z axes and may comprise a non-centrosymmetric ferroelectric polymer. The GRIN material may comprise two or more parallel layers of distinct refractive indices in a uniform progression, where the parallel layers may be in a diagonal orientation to the x, y, and z axes of the GRIN material and may include a uniform dipole orientation. The uniform progression of refractive indices within the GRIN material may be from a relatively higher refractive index to a relatively lower refractive index. The GRIN material may be formed with the variation of the refractive index along the z-axis and a substantially constant refractive index along the x- and y-axes.

In further examples, the GRIN backplane may include a layer of conductive traces on at least one surface of the GRIN material. A concentration of the nanoparticles may be based on refractive indices of the nanoparticles. The nanoparticles may include non-electro-optic nanoparticles and/of electro-optic nanoparticles, where the electro-optic nanoparticles may include non-centrosymmetric ceramic nanoparticles. The portion of the GRIN material may comprise an entirety of the GRIN material. An orientation of the nanoparticles may be changed in response to the electric field, wherein the changed orientation of the nanoparticles may result in the change in the refractive index. The change in the refractive index in response to the electric field, which results in the change in the section of the optical pathway, may provide a routing capability, including, switching capability, in the GRIN material for an optical signal that propagates along the optical path.

According to some embodiments, apparatuses are described. An example apparatus may include a GRIN backplane that includes nanoparticles that determine at least in part a direction of one or more optical pathways within the GRIN backplane based on a variation of at least one refractive index of the GRIN backplane. The example apparatus may also include components on one or more surfaces of the GRIN backplane, where two or more of the components may be communicatively coupled through the optical pathways within the GRIN backplane. The example apparatus may farther include two or more electrodes on at least one surface of the GRIN backplane, where the electrodes may be configured to create an electric field between the electrodes in response to application of a voltage and/or a current. The example apparatus may yet further include an optical interface coupled to an edge of the GRIN backplane, where the optical interface may be configured to receive an optical communication signal and provide the optical communication signal to at least one of the components through the optical pathways within the GRIN backplane, where the nanoparticles may be responsive to the electric field to change the refractive index of the GRIN backplane to cause a change in the direction of the optical pathways.

In other embodiments, the at least one surface of the GRIN backplane may include different surfaces of the GRIN backplane, and the electrodes may be positioned at a location on the different surfaces of the GRIN backplane based on dimensions of the backplane and/or a location of the communicatively coupled components. The electrodes may include shapes and/or sizes that are based on the direction of the one or more optical pathways between the communicatively coupled components, where the shapes may include squares, rectangles, circles, and/or triangles. The communicatively coupled components may be configured to communicate over the optical pathways by use of optical communication signals that include a laser beam, an infrared beam, and/or a visible light beam.

In further embodiments, a portion of the components may include an emitter and/or a detector configured to facilitate transmission and/or reception of optical communication signals. The variation of the refractive index may include non-linear variation, and the GRIN backplane may include one or more non-linear refractive indices such that optical communication signals may be directed to different components cross each other without interference. The variation of the at least one refractive index may include non-linear variation, and the GRIN backplane may include one or more non-linear refractive indices such that two or more optical communication signals may be directed to different components from a single emanation point at the optical interface. The at least one surface of the GRIN backplane may include different surfaces of the GRIN backplane, and the different surfaces of the GRIN backplane may include opposite surfaces of the GRIN backplane.

According to other examples, methods to fabricate a GRIN backplane are provided. An example method may include forming at least one sheet of GRIN material, where the sheet of GRIN material includes at least one refractive index that varies along orthogonal x, y, and/or z axes of the GRIN material. The example method may also include placing nanoparticles into at least a portion of the GRIN material, where a section of at least one optical pathway is formed in the portion of the GRIN material based on the variation of the refractive index, where the nanoparticles may enable the refractive index in the portion of the GRIN material to be changed in response to an electric field. The method may further include mounting two or more electrodes on different surfaces of the sheet of CAIN material, where electrodes may be configured to create the electric field between the different surfaces of the sheet of GRIN material in response to application of electrical excitation to the electrodes.

In other examples, two or more parallel layers of distinct refractive indices in a uniform progression may be formed to form the sheet of GRIN material. The parallel layers may be formed in a diagonal orientation to x, y, and z axes of the sheet of GRIN material. The uniform progression of the refractive indices may be from a relatively higher refractive index to a relatively lower refractive index. A layer of conductive traces may also be formed over at least one surface of the sheet of GRIN material.

According to some embodiments, methods to employ an optical effect to direct an optical communication signal within a GRIN backplane are provided. An example method may include forming an electric field between two or more electrodes located on at least one surface of the GRIN backplane by application of electrical excitation to at least one of the electrodes, where the electric field may be configured to change art orientation of nanoparticles in the GRIN backplane so as to control a direction of one or more optical pathways within the GRIN backplane. The example method may also include facilitating propagation of an optical communication signal between two or more components via the controlled direction of the optical pathways.

In other embodiments, a particular refractive index may be maintained within the electric field by controlling a polarity and a magnitude of the electrical excitation. The optical communication signal may be deflected upon entry and exit of the electric field to control the direction of the optical pathways, where a deuce of deflection may be based at least in part on a strength of the electric field. A distance traveled by the optical communication signal via the optical pathways directed through the electric field may be reduced by maintaining a polarity associated with the GRIN backplane, where the polarity may be determined by a direction of the electric field between the electrodes. The electrical excitation may be increased to further reduce the distance traveled by the optical communication signal via the optical pathways directed through the electric field. The optical effect may include Pockels effect. The electric field may be changed to change the direction of the pathways to control routing, including switching, of the optical communication signal to a particular optical pathway to facilitate the propagation of the optical communication signal.

There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof and that designing the circuitry and/or writing the code for the software and or firmware would be possible in light of this disclosure.

The present disclosure is not to be limited in terms of the particular embodiments described in this application, which are intended as illustrations of various aspects. Many modifications and variations can be made without departing from its spirit and scope Functionally equivalent methods and apparatuses within the scope of the disclosure, in addition to those enumerated herein, will be possible from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, systems, or components, which can, of course, vary, it is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link. etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described, herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should he interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced, claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”) the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc,” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. A gradient index (GRIN) backplane, comprising:
a planarly formed GRIN material, wherein the GRIN material includes at least one refractive index that varies along at least one of orthogonal x, y, and z axes of the GRIN material; and
a plurality of nanoparticles in at least a portion of the GRIN material, wherein a section of at least one optical pathway is formed in the at least the portion of the GRIN material based on variation of the at least one refractive index, wherein the plurality of nanoparticles enable the at least one refractive index in the at least the portion of the GRIN material to be changed in response to an electric field,
wherein the change in the at least one refractive index in response to the electric field results in a change in the section of the at least one optical pathway in the at least the portion of the GRIN material, so as to provide a routing capability, including switching capability, in the GRIN material for an optical signal that propagates along the at least one optical path.

2. The GRIN backplane of claim 1, wherein the at least the portion of the GRIN material includes a column along one of the x, y, and z axes.

3. The GRIN backplane of claim 1, wherein the at least the portion of the GRIN material comprises a non-centrosymmetric ferroelectric polymer.

4. The GRIN backplane of claim 1, wherein the GRIN material comprises two or more parallel layers of distinct refractive indices in a uniform progression.

5. The GRIN backplane of claim 4, wherein the parallel layers are in a diagonal orientation to the x, y, and z axes of the GRIN material.

6. The GRIN backplane of claim 4, wherein the parallel layers include a uniform dipole orientation.

7. The GRIN backplane of claim 4, wherein the uniform progression of refractive indices within the GRIN material is from a relatively higher refractive index to a relatively lower refractive index.

8. The GRIN backplane of claim 1, wherein the GRIN material is formed with the variation of the at least one refractive index along the z-axis and a substantially constant refractive index along the x- and y-axes.

9. The GRIN backplane of claim 1, further comprising a layer of conductive traces on at least one surface of the GRIN material.

10. The GRIN backplane of claim 1, wherein a concentration of the nanoparticles is based on refractive indices of the nanoparticles.

11. The GRIN backplane of claim 1, wherein the nanoparticles include one or more of: non-electro-optic nanoparticles and electro-optic nanoparticles.

12. The GRIN backplane of claim 11, wherein the electro-optic nanoparticles include non-centrosymmetric ceramic nanoparticles.

13. The GRIN backplane of claim 1, wherein the at least the portion of the GRIN material comprises an entirety of the GRIN material.

14. The GRIN backplane of claim 1, wherein an orientation of the nanoparticles is changed in response to the electric field, wherein the changed orientation of the nanoparticles results in the change in the at least one refractive index.

15. (canceled)

16. An apparatus, comprising:
a gradient index (GRIN) backplane that includes nanoparticles that determine at least in part a direction of one or more optical pathways within the GRIN backplane based on a variation of at least one refractive index of the GRIN backplane;
a plurality of components on one or more surfaces of the GRIN backplane, wherein two or more of the components are communicatively coupled through the one or more optical pathways within the GRIN backplane;
two or more electrodes on at least one surface of the GRIN backplane, wherein the two or more electrodes are configured to create an electric field between the two or more electrodes in response to application of one or more of: a voltage and a current; and
an optical interface coupled to an edge of the GRIN backplane, wherein the optical interface is configured to receive an optical communication signal and provide the optical communication signal to at least one of the components through the one or more of the optical pathways within the GRIN backplane,
wherein the nanoparticles are responsive to the electric field to change the at least one refractive index of the GRIN backplane to cause a change in the direction of the one or more optical pathways.

17. The apparatus of claim 16, wherein the at least one surface of the GRIN backplane includes different surfaces of the GRIN backplane, and wherein the two or more electrodes are positioned at a location on the different surfaces of the GRIN backplane based on one or more of: dimensions of the backplane and a location of the two or more communicatively coupled components.

18. The apparatus of claim 16, wherein the two or more electrodes include shapes and/or sizes that are based on the direction of the one or more optical pathways between the two or more communicatively coupled components.

19. The apparatus of claim 18, wherein the shapes of the two or more electrodes include one or more of squares, rectangles, circles, and triangles.

20. The apparatus of claim 18, wherein the two or more communicatively coupled components are configured to communicate over the one or more optical pathways by use of optical communication signals that include one or more of: a laser beam, an infrared beam, and a visible light beam.

21. The apparatus of claim 16, wherein a portion of the components includes at least one of an emitter and/or a detector configured to facilitate transmission and/or reception of optical communication signals.

22. The apparatus of claim 16, wherein variation of the at least one refractive index includes non-linear variation, and wherein the GRIN backplane includes one or more non-linear refractive indices such that optical communication signals directed to different components cross each other without interference.

23. The apparatus of claim 16, wherein variation of the at least one refractive index includes non-linear variation, and wherein the GRIN backplane includes one or more non-linear refractive indices such that two or more optical communication signals are directed to different components from a single emanation point at the optical interface.

24. The apparatus of claim 16, wherein the at least one surface of the GRIN backplane includes different surfaces of the GRIN backplane, and wherein the different surfaces of the GRIN backplane include opposite surfaces of the GRIN backplane.

25. A method to fabricate a gradient index (GRIN) backplane, the method comprising:
forming at least one sheet of GRIN material, wherein the at least one sheet of GRIN material includes at least one refractive index that varies alone, at least one of orthogonal x, y, and z axes of the GRIN material;
placing a plurality of nanoparticles into at least a portion of the GRIN material, wherein a section of at least one optical pathway is formed in the at least the portion of the GRIN material based on the variation of the at least one refractive index, wherein the plurality of nanoparticles enable the at least one refractive index in the at least the portion of the GRIN material to be changed in response to an electric field; and
mounting two or more electrodes on different surfaces of the sheet of GRIN material, wherein the two or more electrodes are configured to create the electric field between the different surfaces of the at least one sheet of GRIN material in response to application of electrical excitation to the two or more electrodes.

26-29. (canceled)

30. A method to employ an optical effect to direct an optical communication signal within a gradient index (GRIN) backplane, the method comprising:
forming an electric field between two or more electrodes located on at least one surface of the GRIN backplane by application of electrical excitation to at least one of the electrodes, wherein the electric field is configured to change an orientation of a plurality of nanoparticles in the GRIN backplane so as to control a direction of one or more optical pathways within the GRIN backplane; and
facilitating propagation of an optical communication signal between two or more components via the controlled direction of the one or more optical pathways.

31. The method of claim 30, wherein application of the electrical excitation includes application of at least one of a voltage or a current, the method further comprising:
maintaining a particular refractive index within the electric, field by controlling a polarity and a magnitude of the applied electrical excitation.

32. The method of claim 30, wherein the control of the direction of the one or more optical pathways includes:
deflecting the optical communication signal upon entry and exit of the electric, field, wherein a degree of deflection is based at least in part on a strength of the electric field,

33. The method of claim 30, further comprising:
reducing a distance traveled by the optical communication signal via the one or more optical pathways directed through the electric field by maintaining a polarity associated with the GRIN backplane, wherein the polarity is determined by a direction of the electric field between the two or more electrodes.

34. The method of claim 33, further comprising:
increasing the electrical excitation to further reduce the distance traveled by the optical communication signal via, the one or more optical pathways directed through the electric field.

35. The method of claim 30, wherein the optical effect includes Pockels effect, and wherein facilitating the propagation of the optical communication signal includes changing the electric field to change the direction of the one or more optical pathways to control routing, including switching, of the optical communication signal to a particular optical pathway.
